(19) United States
(12) Patent Application Publication
(10) Pub. No.: US 2025/0239898 A1
(43) Pub. Date: Jul. 24, 2025

(54) MAGNETIC CORE, COIL-EQUIPPED MAGNETIC CORE, ROTATING ELECTRICAL MACHINE, AND BRUSHLESS MOTOR

(71) Applicant: Murata Manufacturing Co., Ltd., Nagaokakyo-shi (JP)

(72) Inventors: Hisato AMANO, Nagaokakyo-shi (JP); Kazuyoshi ISHIZUKA, Nagaokakyo-shi (JP); Ryosuke YAMAMOTO, Nagaokakyo-shi (JP); Mitsutoshi NATSUMEDA, Nagaokakyo-shi (JP); Takashi SAKURADA, Nagaokakyo-shi (JP)

(21) Appl. No.: 19/081,342

(22) Filed: Mar. 17, 2025

Related U.S. Application Data
(63) Continuation of application No. PCT/JP2023/042586, filed on Nov. 28, 2023.

(30) Foreign Application Priority Data
Dec. 5, 2022 (JP) 2022-194083

(51) Int. Cl. H02K 1/16

(52) U.S. Cl. CPC H02K 1/165

(57) ABSTRACT

A magnetic core that includes a tooth portion extending in a first direction. The tooth portion includes a winding portion around which a coil is to be wound, and the winding portion includes a first protruding corner, a first contact surface that has a curved shape protruding in a second direction when viewed in the first direction, a first non-contact surface that shares a boundary with the first contact surface at the first protruding corner, and a second contact surface that has a curved shape protruding in a third direction different from the second direction when viewed in the first direction.

### CROSS REFERENCE TO RELATED APPLICATIONS

The present application is a continuation of International application No. PCT/JP2023/042586, filed Nov. 28, 2023, which claims priority to Japanese Patent Application No. 2022-194083, filed Dec. 5, 2022, the entire contents of each of which are incorporated herein by reference.

### TECHNICAL FIELD

The present disclosure relates to a magnetic core, a coil-equipped magnetic core, a rotating electrical machine, and a brushless motor.

### BACKGROUND ART

Examples of known inventions concerning conventional magnetic cores include the magnetic core disclosed in Patent Document 1. The magnetic core disclosed in Patent Document 1 includes a tooth portion. A coil is wound around the tooth portion. An insulating film is formed on the surface of the coil. The tooth portion has a quadrangular shape when viewed in the extending direction of the tooth portion. In the state in which the coil is wound around the tooth portion, the insulating film formed on the surface of the coil is in contact with the four vertices of the tooth portion.
Patent Document 1: Japanese Unexamined Patent Application Publication No. 2006-158176

### SUMMARY OF THE DISCLOSURE

In the magnetic core disclosed in Patent Document 1, since the insulating film formed on the surface of the coil comes into contact with the four vertices of the tooth portion, stress is concentrated at the portion of the insulating film in contact with each vertex, and there is a possibility that the insulating film can be damaged. This can degrade the electrical insulation between the magnetic core and the coil.

In view of the above, an object of the present disclosure is to provide a magnetic core that reduces the degradation of the electrical insulation between the magnetic core and the coil due to the damage of the insulating film formed on the surface of the coil, a coil-equipped magnetic core, a rotating electrical machine, and a brushless motor.

The inventors of the present application examined cases in which the damage of the insulating film formed on the surface of the coil degrades the electrical insulation between the magnetic core and the coil, and found that forming the tooth portion in the magnetic core disclosed in Patent Document 1 to have an elliptical shape or a circular shape when viewed in the extending direction of the tooth portion solves the problem. This is because in the case of forming the tooth portion to have an elliptical shape or a circular shape when viewed in the extending direction of the tooth portion, the tooth portion has no vertices, and this configuration allows the bending angle of each portion of the coil to be larger than 90 degrees, mitigating stress being concentrated at certain portions of the insulating film formed on the surface of the coil.

Then, the inventors of the present application studied the method of manufacturing the tooth portion having an elliptical shape or a circular shape when viewed in the extending direction of the tooth portion. In the case of manufacturing the tooth portion having an elliptical shape or a circular shape when viewed in the extending direction of the tooth portion by the manufacturing method disclosed in Patent Document 1, the lower end surface of the punch 201 (hereinafter also referred to as the upper punch) disclosed in Patent Document 1 needs to have a semi-elliptical shape or a semicircular shape curved to protrudes upward, and the upper end surface of the punch 202 (hereinafter also referred to as the lower punch) disclosed in Patent Document 1 needs to have a semi-elliptical shape or a semicircular shape curved to protrudes downward.

In the case of forming the tooth portion to have an elliptical shape or a circular shape when viewed in the extending direction of the tooth portion, it is ideally preferable that the entire lower end surface of the upper punch be curved to have a semi-elliptical shape or a semicircular shape so that flat portions will not remain at both end portions and that the entire upper end surface of the lower punch be curved to have a semi-elliptical shape or a semicircular shape so that flat portions will not remain at both end portions.

However, flat portions actually remain in both ends portions of the lower end surface of the upper punch and the upper end surface of the lower punch due to problems with machining accuracy and the strength of molds. Hence, in the case in which the tooth portion is formed with the upper punch and the lower punch, the tooth portion will have protrusions formed by being pressed by the upper and lower flat portions. Then, when the coil is wound around the tooth portion, such protrusions can damage the insulating film of the coil, degrading the electrical insulation between the tooth portion and the coil.

On the basis of the study mentioned above, the inventor of the present application studied a magnetic core that reduces the degradation of the electrical insulation between the magnetic core and the coil due to the damage of the insulating film formed on the surface of the coil. Thus, the inventor of the present application conceived the disclosure mentioned below.

A magnetic core according to an aspect of the present disclosure is a magnetic core for a rotating electrical machine, including: a tooth portion having a shape extending in a first direction, wherein the tooth portion includes a winding portion around which a coil is to be wound, and the winding portion includes: a first protruding corner constructed such that the coil passes thereby when the coil is wound on the winding portion, a first contact surface constructed such that the coil comes into contact therewith before passing by the first protruding corner when the coil is wound on the winding portion, and that has a first curved shape protruding in a second direction when viewed in the first direction, a first non-contact surface constructed such that the coil does not come into contact therewith when the coil is wound on the winding portion, and that shares a boundary with the first contact surface at the first protruding corner, and a second contact surface constructed such that the coil comes into contact therewith after passing by the first protruding corner when the coil is wound on the winding portion, and that has a second curved shape protruding in a third direction different from the second direction when viewed in the first direction.

A magnetic core according to an aspect of the present disclosure is a magnetic core for a rotating electrical machine, including: a tooth portion having a shape extending in a first direction, wherein the tooth portion includes a winding portion around which a coil is to be wound, and the winding portion includes: a first protruding corner constructed such that the coil passes thereby when the coil is wound on the winding portion, a first contact surface constructed such that the coil comes into contact therewith before passing by the first protruding corner when the coil is wound on the winding portion, and that has a first curved shape protruding in a second direction when viewed in the first direction, a second contact surface constructed such that the coil comes into contact therewith after passing by the first protruding corner when the coil is wound on the winding portion, a first non-contact surface between the first contact surface and the second contact surface, constructed such that the coil does not come into contact therewith when the coil is wound on the winding portion, and that shares a boundary with the second contact surface at the first protruding corner, a second protruding corner constructed such that the coil passes thereby after passing along the second contact surface when the coil is wound on the winding portion, a third contact surface constructed such that the coil comes into contact therewith after passing by the second protruding corner when the coil is wound on the winding portion, and that has a third curved shape protruding in a third direction different from the second direction when viewed in the first direction, and a second non-contact surface between the second contact surface and the third contact surface, constructed such that the coil does not come into contact therewith when the coil is wound on the winding portion, and that shares a boundary with the second contact surface at the second protruding corner.

With the present disclosure, it is possible to provide a magnetic core that reduces the degradation of the electrical insulation between the magnetic core and the coil due to the damage of the insulating film formed on the surface of the coil, a coil-equipped magnetic core, a rotating electrical machine, and a brushless motor.

### BRIEF DESCRIPTION OF THE DRAWINGS

FIG. 1 is a perspective view of a magnetic core 1 according to a first embodiment of the present disclosure.

FIG. 2 is a cross-sectional view of the magnetic core 1 viewed in a first direction DIR1.

FIG. 3 is a cross-sectional view in the first direction DIR1, showing a process in which a coil 13 is wound around a tooth main-body portion 31 of the magnetic core 1.

FIG. 4 is a cross-sectional view in the first direction DIR1, showing the process in which the coil 13 is wound around the tooth main-body portion 31 of the magnetic core 1.

FIG. 5 is a cross-sectional view in the first direction DIR1, showing the process in which the coil 13 is wound around the tooth main-body portion 31 of the magnetic core 1.

FIG. 6 is a cross-sectional view in the first direction DIR1, showing the process in which the coil 13 is wound around the tooth main-body portion 31 of the magnetic core 1.

FIG. 7 is a cross-sectional view in the first direction DIR1, showing the process in which the coil 13 is wound around the tooth main-body portion 31 of the magnetic core 1.

FIG. 8 is a perspective view of an outer appearance of a brushless motor 100 in which the magnetic core 1 is used.

FIG. 9 is a schematic perspective view of a disassembled brushless motor 100 in which the magnetic core 1 is used.

FIG. 10 is a cross-sectional view in the first direction DIR1, showing a process in which the coil 13 is wound around a tooth main-body portion 31 of a magnetic core 6 according to a comparative example.

FIG. 11 is a cross-sectional view of a magnetic core 1a viewed in the first direction DIR1.

FIG. 12 is a cross-sectional view in the first direction DIR1, showing a process in which a coil 13 is wound around a tooth main-body portion 31 of the magnetic core 1a.

FIG. 13 is a cross-sectional view in the first direction DIR1, showing the process in which the coil 13 is wound around the tooth main-body portion 31 of the magnetic core 1a.

FIG. 14 is a cross-sectional view in the first direction DIR1, showing the process in which the coil 13 is wound around the tooth main-body portion 31 of the magnetic core 1a.

FIG. 15 is a cross-sectional view in the first direction DIR1, showing the process in which the coil 13 is wound around the tooth main-body portion 31 of the magnetic core 1a.

FIG. 16 is a cross-sectional view in the first direction DIR1, showing the process in which the coil 13 is wound around the tooth main-body portion 31 of the magnetic core 1a.

FIG. 17 is a cross-sectional view in the first direction DIR1, showing the process in which the coil 13 is wound around the tooth main-body portion 31 of the magnetic core 1a.

FIG. 18 is a cross-sectional view in the first direction DIR1, showing the process in which the coil 13 is wound around the tooth main-body portion 31 of the magnetic core 1a.

FIG. 19 is a cross-sectional view in the first direction DIR1, showing the process in which the coil 13 is wound around the tooth main-body portion 31 of the magnetic core 1a.

FIG. 20 is a cross-sectional view in the first direction DIR1, showing the process in which the coil 13 is wound around the tooth main-body portion 31 of the magnetic core 1a.

FIG. 21 is a cross-sectional view of a magnetic core 1b viewed in the first direction DIR1.

### DESCRIPTION OF THE PREFERRED EMBODIMENTS

### First Embodiment

### (Configuration of Magnetic Core 1)

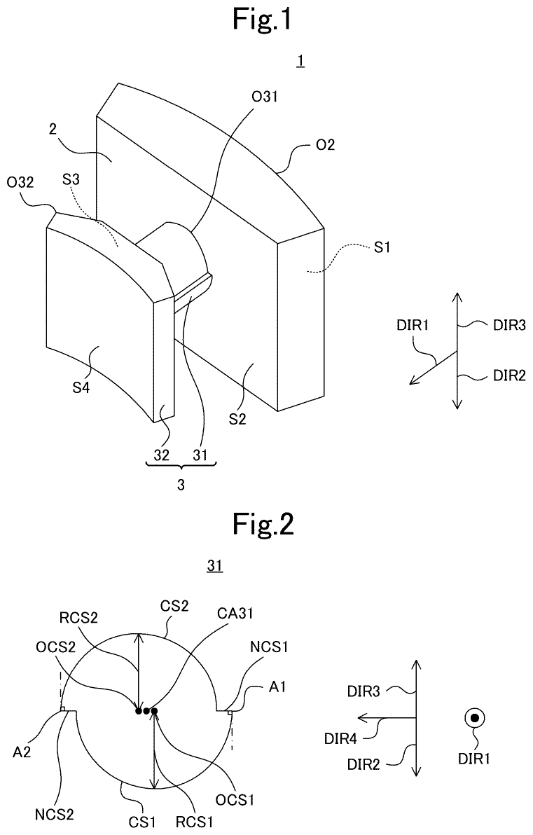

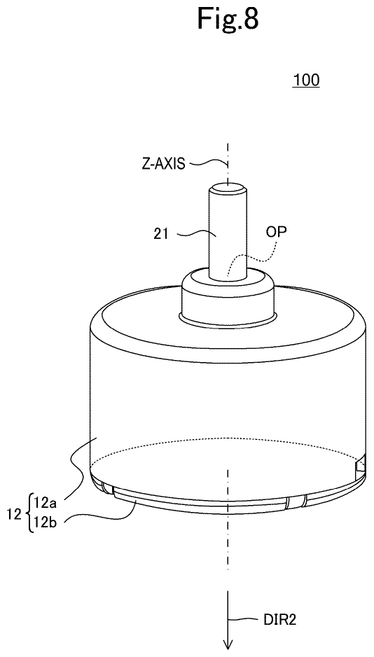

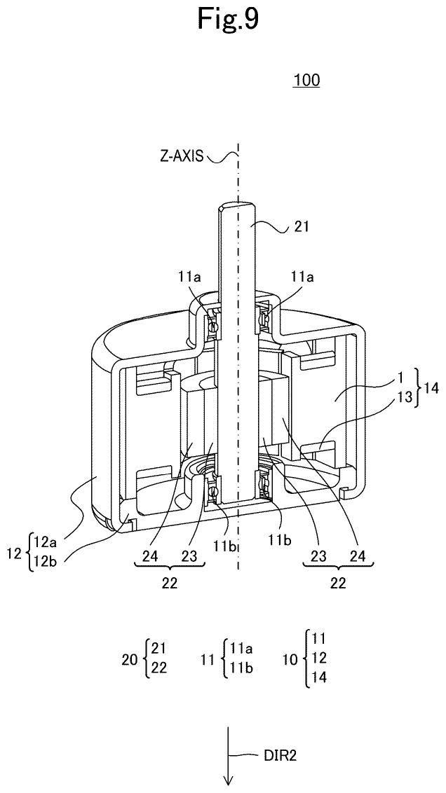

FIG. 1 is a perspective view of a magnetic core 1 according to a first embodiment of the present disclosure. As illustrated in FIG. 1, the magnetic core 1 includes a core back portion 2 and a tooth portion 3. The tooth portion 3 has a shape extending from the core back portion 2 in a first direction DIR1. In the present embodiment, the tooth portion 3 includes a tooth main-body portion 31 extending from the core back portion 2 in the first direction DIR1 and a tooth distal-end portion 32 formed at the distal end of the tooth main-body portion 31 in the first direction DIR1. The tooth main-body portion 31 is the portion around which a coil 13 is wound, and corresponds to a “winding portion” of the present disclosure. The magnetic core 1 of the present embodiment mentioned above is used in a brushless motor 100 described later (an example of a “rotating electrical machine” of the present disclosure, see FIGS. 8 and 9). In the state in which the brushless motor 100 is assembled in the magnetic core 1, the first direction DIR1 corresponds to the opposite direction to a radial direction centered on the rotation axis of the brushless motor 100. Hereinafter, a specific description will be provided.

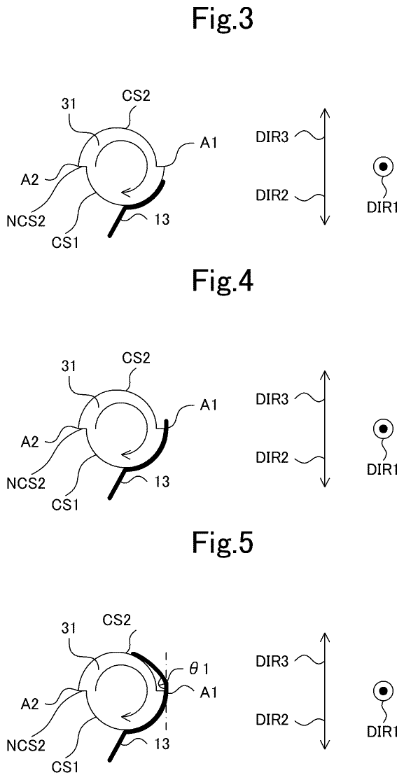

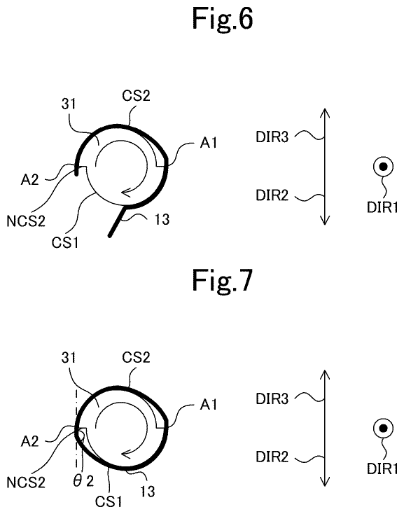

FIG. 2 is a cross-sectional view of the magnetic core 1 viewed in the first direction DIR1. FIG. 3 is a cross-sectional view in the first direction DIR1, showing a process in which the coil 13 is wound around the tooth main-body portion 31 of the magnetic core 1. FIG. 4 is a cross-sectional view in the first direction DIR1, showing the process in which the coil 13 is wound around the tooth main-body portion 31 of the magnetic core 1. FIG. 5 is a cross-sectional view in the first direction DIR1, showing the process in which the coil 13 is wound around the tooth main-body portion 31 of the magnetic core 1. FIG. 6 is a cross-sectional view in the first direction DIR1, showing the process in which the coil 13 is wound around the tooth main-body portion 31 of the magnetic core 1. FIG. 7 is a cross-sectional view in the first direction DIR1, showing the process in which the coil 13 is wound around the tooth main-body portion 31 of the magnetic core 1.

The magnetic core 1 is composed of a soft magnetic material. A soft magnetic material is magnetized when an external magnetic field is applied to it. After that, when the application of the magnetic field is stopped, the soft magnetic material loses the magnetization. Examples of such soft magnetic materials include iron.

The magnetic core 1 is a molded body formed of soft magnetic powder. Specifically, each of the core back portion 2 and the tooth portion 3 is a molded body formed of soft magnetic powder. The material of the soft magnetic powder contains, for example, iron and a binder. The binder is, for example, a resin. The soft magnetic powder is, for example, a mixture of iron powder and epoxy resin which is an example of a binder. The magnetic core 1 described above is produced by, for example, press molding. The outer surface of the magnetic core 1 that is in contact with other members in the state in which the magnetic core 1 is assembled in the brushless motor 100 is subjected to an insulation treatment.

As illustrated in FIG. 1, the core back portion 2 has a first main surface S1 and a second main surface S2 aligned in the first direction DIR1. The second main surface S2 is positioned in the first direction DIR1 relative to the first main surface S1. Each of the first main surface S1 and the second main surface S2 has a rectangular shape when viewed in the first direction DIR1.

As illustrated in FIG. 1, the tooth main-body portion 31 extends from the second main surface S2 of the core back portion 2 in the first direction DIR1.

As illustrated in FIG. 2, the tooth main-body portion 31 includes a first contact surface CS1, a first protruding corner A1, a first non-contact surface NCS1, a second contact surface CS2, a second protruding corner A2, and a second non-contact surface NCS2.

As illustrated in FIG. 2, the first contact surface CS1 has a curved shape protruding in a second direction DIR2. More specifically, the first contact surface CS1 has a semi-elliptical shape when viewed in the first direction DIR1. Note that a semicircular shape is included in the category of semi-elliptical shapes. In the present embodiment, the first contact surface CS1 has a semicircular shape when viewed in the first direction DIR1. Specifically, the first contact surface CS1 is part of a circle centered on a center OCS1 and having a radius RCS1 when viewed in the first direction DIR1. Note that the second direction DIR2 is orthogonal to the first direction DIR1. The second direction DIR2 is a direction parallel to the rotation axis of the brushless motor 100 in the state in which the magnetic core 1 is assembled in the brushless motor 100.

As illustrated in FIG. 2, the first non-contact surface NCS1 is a flat surface facing a third direction DIR3. In other words, the normal line direction of the first non-contact surface NCS1 corresponds to the third direction DIR3. Note that the third direction DIR3 is a direction orthogonal to the first direction DIR1 and different from the second direction DIR2. The third direction DIR3 is the opposite direction to the second direction DIR2.

In the present embodiment, as illustrated in FIG. 2, the first protruding corner A1 is a corner formed by the first contact surface CS1 and the tangent line of the first non-contact surface NCS1 at the first protruding corner A1 when viewed in the first direction DIR1. More specifically, the first protruding corner A1 protrudes in a radial direction centered on the center axis CA31 of the tooth main-body portion 31 when viewed in the first direction DIR1. Hence, the boundary between the first non-contact surface NCS1 and the first contact surface CS1 is the first protruding corner A1. The first protruding corner A1 is positioned on the first contact surface CS1. Note that the center axis CA31 of the tooth main-body portion 31 is the line connecting the centers of cross sections of the tooth main-body portion 31 perpendicular to the first direction DIR1. In the present embodiment, the angle of the first protruding corner A1 is 90 degrees.

As illustrated in FIG. 2, the second contact surface CS2 is positioned in the third direction DIR3 relative to the first contact surface CS1. The second contact surface CS2 has a curved shape protruding in the third direction DIR3 when viewed in the first direction DIR1. More specifically, the second contact surface CS2 has a semi-elliptical shape when viewed in the first direction DIR1. Note that a semicircular shape is included in the category of semi-elliptical shapes. In the present embodiment, the second contact surface CS2 has a semicircular shape when viewed in the first direction DIR1. Specifically, the second contact surface CS2 is part of a circle centered on a center OCS2 and having a radius RCS2 when viewed in the first direction DIR1. The radius RCS2 of the second contact surface CS2 is equal to the radius RCS1 of the first contact surface CS1. Note that the position of the center OCS2 in the fourth direction DIR4 orthogonal to the first direction DIR1 and the second direction DIR2 differs from the position of the center OCS1 in the fourth direction DIR4.

As illustrated in FIG. 2, the second non-contact surface NCS2 is a flat surface facing the second direction DIR2. In other words, the normal line direction of the second non-contact surface NCS2 corresponds to the second direction DIR2.

As illustrated in FIG. 2, the second protruding corner A2 is a protruding corner different from the first protruding corner A1. More specifically, in the present embodiment, the second protruding corner A2 is a corner formed by the second contact surface CS2 and the tangent line of the second non-contact surface NCS2 at the second protruding corner A2 when viewed in the first direction DIR1. More specifically, the second protruding corner A2 protrudes in a radial direction centered on the center axis CA31 of the tooth main-body portion 31 when viewed in the first direction DIR1. Hence, the boundary between the second non-contact surface NCS2 and the second contact surface CS2 is the second protruding corner A2. The second protruding corner A2 is positioned on the second contact surface CS2. In the present embodiment, the angle of the second protruding corner A2 is 90 degrees.

As illustrated in FIG. 2, the tooth main-body portion 31 has a point-symmetric shape when viewed in the first direction DIR1.

The coil 13 is wound around the tooth main-body portion 31 as illustrated in FIGS. 3 to 7. The coil 13 is made of, for example, a conductive material such as copper. The coil 13 has a structure in which the surface of a copper wire is covered with an insulating film. The structure in which the surface of a copper wire is covered with an insulating film electrically insulates the coil 13 and the magnetic core 1 from each other. In the state in which the coil 13 is assembled in the brushless motor 100, when a current flow in the coil 13, the coil 13 generates a magnetic field.

A process in which the coil 13 is wound around the tooth main-body portion 31 will be described below. First, as illustrated in FIG. 3, the coil 13 comes into contact with the first contact surface CS1. Specifically, the coil 13 comes into contact with the first contact surface CS1 before passing by the first protruding corner A1.

Next, as illustrated in FIG. 4, the coil 13 passes by the first protruding corner A1. In other words, the coil 13 comes into contact with the first protruding corner A1.

Next, as illustrated in FIG. 5, the coil 13 comes into contact with the second contact surface CS2.

Specifically, after the coil 13 passes by the first protruding corner A1, the coil 13 comes into contact with the second contact surface CS2. The coil 13 does not come into contact with the first non-contact surface NCS1. The bending angle θ1 of the coil 13 between the first protruding corner A1 and the second contact surface CS2 is larger than 90 degrees.

Next, as illustrated in FIG. 6, the coil 13 passes by the second protruding corner A2. Specifically, after the coil 13 passes along the second contact surface CS2, the coil 13 passes by the second protruding corner A2. The coil 13 comes into contact with the second protruding corner A2.

Next, as illustrated in FIG. 7, the coil 13 comes into contact with the first contact surface CS1.

Specifically, after the coil 13 passes by the second protruding corner A2, the coil 13 comes into contact with the first contact surface CS1 again. The coil 13 does not come into contact with the second non-contact surface NCS2. The bending angle θ2 of the coil 13 between the first contact surface CS1 and the second protruding corner A2 is larger than 90 degrees.

By repeating the process described above, the coil 13 is wound around the tooth main-body portion 31.

The tooth distal-end portion 32 has a third main surface S3 and a fourth main surface S4 aligned in the first direction DIR1. The fourth main surface S4 is positioned in the first direction DIR1 relative to the third main surface S3. Each of the third main surface S3 and the fourth main surface S4 has a rectangular shape when viewed in the first direction DIR1.

As illustrated in FIG. 1, the outer edge O2 of the core back portion 2 viewed in the first direction DIR1 surrounds the outer edge O31 of the tooth main-body portion 31 viewed in the first direction DIR1. The outer edge O32 of the tooth distal-end portion 32 viewed in the first direction DIR1 surrounds the outer edge O31 of the tooth main-body portion 31 viewed in the first direction DIR1.

### (Configuration of Brushless Motor 100)

Hereinafter, the configuration of the brushless motor 100 according to the first embodiment of the present disclosure will be described with reference to drawings. FIG. 8 is a perspective view of an outer appearance of the brushless motor 100 in which the magnetic core 1 is used. FIG. 9 is a schematic perspective view of a disassembled brushless motor 100 in which the magnetic core 1 is used. In FIG. 9, out of a plurality of magnetic cores 1, a plurality of coils 13, and a plurality of coil-equipped magnetic cores 14, only one representative of each is denoted by a reference symbol.

As illustrated in FIG. 9, the brushless motor 100 includes a rotor 20 and a stator assembly 10. As illustrated in FIG. 9, the stator assembly 10 is located around the rotor 20 when viewed in the second direction DIR2. In other words, the brushless motor 100 is an inner rotor motor.

As illustrated in FIG. 9, the rotor 20 includes a shaft 21 and a rotor member 22. The shaft 21 has a shape extending in the second direction DIR2. More specifically, the shaft 21 has a columnar shape. The rotor member 22 has a cylindrical shape. The center axis of each of the shaft 21 and the rotor member 22 corresponds to the Z-axis. In other words, the rotation axis of the brushless motor 100 corresponds to the Z-axis. Hence, the second direction DIR2 is parallel to the Z-axis.

As illustrated in FIG. 9, the rotor member 22 includes a soft magnetic material 23 and a hard magnetic material 24. The rotor member 22 is attached to the outer peripheral surface of the shaft 21 in the radial directions centered on the Z-axis. More specifically, the soft magnetic material 23 is attached to the outer peripheral surface of the shaft 21 in the radial directions centered on the Z-axis. The hard magnetic material 24 is attached to the outer peripheral surface of the soft magnetic material 23 in the radial directions centered on the Z-axis.

The soft magnetic material 23 is composed of a soft magnetic material. The hard magnetic material 24 is composed of a hard magnetic material. A hard magnetic material is magnetized when an external magnetic field is applied. After that, even after the application of the magnetic field is stopped, the hard magnetic material does not lose the magnetization. Examples of such hard magnetic materials include a magnet.

As illustrated in FIG. 9, the stator assembly 10 includes bearings 11, a housing 12, and the plurality of coil-equipped magnetic cores 14. Each of the coil-equipped magnetic cores 14 includes a magnetic core 1 and a coil 13. Hence, the brushless motor 100 includes the magnetic core 1.

The bearings 11 support the shaft 21 so that the shaft 21 can rotate in the circumferential direction centered on the Z-axis. More specifically, the bearings 11 are composed of a first bearing 11a and a second bearing 11b as illustrated in FIG. 9. Each of the first bearing 11a and the second bearing 11b is, for example, a ball bearing. The first bearing 11a and the second bearing 11b each have a cylindrical shape. The center axis of each of the first bearing 11a and the second bearing 11b corresponds to the Z-axis. In other words, the center axis of each of the first bearing 11a and the second bearing 11b coincides with the center axis of the shaft 21.

As illustrated in FIG. 9, the second bearing 11b is positioned in the opposite direction to the second direction DIR2 relative to the first bearing 11a. The first bearing 11a is positioned in the second direction DIR2 relative to the rotor member 22. The second bearing 11b is positioned in the opposite direction to the second direction DIR2 relative to the rotor member 22. The second bearing 11b supports the end of the shaft 21 in the second direction DIR2.

As illustrated in FIG. 8, the housing 12 includes a first housing 12a and a second housing 12b. As illustrated in FIGS. 8 and 9, the first housing 12a has a cylindrical shape. The center axis of the first housing 12a corresponds to the Z-axis. The first housing 12a is positioned in the second direction DIR2 relative to the second housing 12b. The first housing 12a has an opening OP. With this configuration, the end of the shaft 21 in the second direction DIR2 protrudes through the opening OP in the second direction DIR2. In other words, the brushless motor 100 is a single-shaft motor.

The first housing 12a supports the first bearing 11a, the plurality of magnetic cores 1, and the plurality of coils 13. The second housing 12b supports the second bearing 11b. Each of the first housing 12a and the second housing 12b is composed of, for example, a material having high stiffness such as stainless steel.

The number of coil-equipped magnetic cores 14 is nine. The nine coil-equipped magnetic cores 14 are aligned in the circumferential direction centered on the Z-axis. The nine coil-equipped magnetic cores 14 are arranged at a distance from the hard magnetic material 24 so as to encircle it.

The magnetic core 1 is magnetized by each of the magnetic field generated by the hard magnetic material 24 and the magnetic field generated by the coil 13, which is described later. Note that an air gap is present between the magnetic core 1 and the rotor member 22 as illustrated in FIG. 9.

The coil 13 is supplied with current from a power supply (not illustrated). The rotation of the rotor 20 is controlled by controlling this current.

### Advantageous Effects

The magnetic core 1 reduces the degradation of the electrical insulation between the magnetic core and the coil due to the damage of the insulating film formed on the surface of the coil. More specifically, the magnetic core 1 includes the first contact surface CS1 having a curved shape protruding in the second direction DIR2 when viewed in the first direction DIR1 which is the extending direction of the tooth portion 3, the first protruding corner A1 which the coil 13 passes by, and the first non-contact surface NCS1 sharing a boundary with the first contact surface CS1 at the first protruding corner A1, and the second contact surface CS2 having a curved shape protruding in the third direction DIR3 different from the second direction DIR2 when viewed in the first direction DIR1 which is the extending direction of the tooth portion 3. The coil 13 does not come into contact with the first non-contact surface NCS1. This configuration allows the bending angle θ1 of the coil 13 between the first protruding corner A1 and the second contact surface CS2 to be larger than 90 degrees. This mitigates stress being concentrated at a certain portion of the insulating film formed on the surface of the coil 13, reducing the damage of the insulating film. Thus, the magnetic core 1 reduces the degradation of the electrical insulation between the magnetic core and the coil due to the damage of the insulating film formed on the surface of the coil.

In the magnetic core 1, the surface area of the outer surface of the magnetic core 1 on which insulation treatment is performed can be small. More specifically, the first non-contact surface NCS1 does not come into contact with the coil 13. Hence, the first non-contact surface NCS1 need not be subjected to insulation treatment. Thus, in the magnetic core 1, the surface area of the outer surface of the magnetic core 1 on which insulation treatment is performed can be small. In addition, since this configuration reduces the damage of the insulating film formed on the surface of the coil 13, a configuration without insulation treatment on the entire outer surface of the magnetic core 1 is possible.

The magnetic core 1 further reduces the degradation of the electrical insulation between the magnetic core and the coil. More specifically, the first non-contact surface NCS1 does not come into contact with the coil 13. Accordingly, the contact area between the magnetic core 1 and the coil 13 can be small. Thus, the magnetic core 1 further reduces the degradation of the electrical insulation between the magnetic core and the coil.

In addition, the magnetic core 1 further reduces the degradation of the electrical insulation between the magnetic core and the coil due to the damage of the insulating film formed on the surface of the coil. More specifically, the magnetic core 1 further includes the second protruding corner A2 which the coil 13 passes by after passing along the second contact surface CS2 and the second non-contact surface NCS2 sharing a boundary with the second contact surface CS2 at the second protruding corner A2. The coil 13 does not come into contact with the second non-contact surface NCS2. This configuration allows the bending angle θ2 of the coil 13 between the second protruding corner A2 and the first contact surface CS1 to be larger than 90 degrees. Hence, it is possible to mitigate stress being concentrated at a certain portion of the insulating film formed on the surface of the coil 13, reducing the damage of the insulating film. Thus, the magnetic core 1 reduces the degradation of the electrical insulation between the magnetic core and the coil due to the damage of the insulating film formed on the surface of the coil.

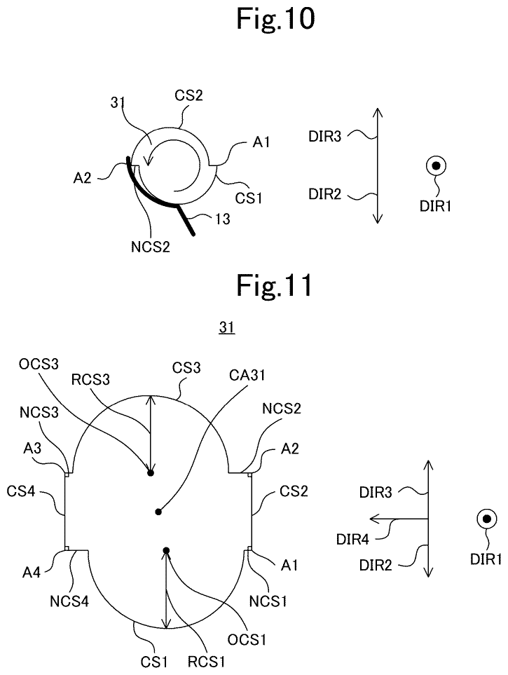

In addition, the magnetic core 1 reduces the degradation of the electrical insulation between the magnetic core and the coil due to the damage of the insulating film formed on the surface of the coil when the coil is wound around the tooth main-body portion. The reason will be described with reference to drawings. FIG. 10 is a cross-sectional view in the first direction DIR1, showing a process in which a coil 13 is wound around a tooth main-body portion 31 of a magnetic core 6 according to a comparative example. Note that the shape of the magnetic core 6 according to the comparative example is the same as the shape of the magnetic core 1.

In the magnetic core 6 according to the comparative example, when the coil 13 is wound around the tooth main-body portion 31, the coil 13 comes into contact with the first contact surface CS1, the second protruding corner A2, the second contact surface CS2, the first protruding corner A1, and the first contact surface CS1 in this order.

Specifically, the magnetic core 6 according to the comparative example differs from the magnetic core 1 in that the winding direction of the coil 13 is opposite to the winding direction of the coil 13 on the magnetic core 1. In the case of the magnetic core 6 according to the comparative example, when the coil 13 proceeds from the first contact surface CS1 to the second protruding corner A2, the coil 13 comes into contact with the second protruding corner A2 as illustrated in FIG. 10, and this can damage the insulating film of the coil 13. In addition, when the coil 13 proceeds from the second contact surface CS2 to the first protruding corner A1, the coil 13 comes into contact with the first protruding corner A1, and this can damage the insulating film of the coil 13. To address this, in the case of the magnetic core 1, when the coil 13 is wound around the tooth main-body portion 31, the coil 13 comes into contact with the first contact surface CS1, the first protruding corner A1, the second contact surface CS2, the second protruding corner A2, and the first contact surface CS1 in this order. The first protruding corner A1 is positioned on the first contact surface CS1. This reduces the damage of the insulating film of the coil 13 caused by the coil 13 coming into contact with the first protruding corner A1 when the coil 13 proceeds from the first contact surface CS1 to the first protruding corner A1. In addition, the second protruding corner A2 is positioned on the second contact surface CS2. This reduces the damage of the insulating film of the coil 13 caused by the coil 13 coming into contact with the second protruding corner A2 when the coil 13 proceeds from the second contact surface CS2 to the second protruding corner A2. Thus, the magnetic core 1 reduces the degradation of the electrical insulation between the magnetic core and the coil due to the damage of the insulating film formed on the surface of the coil when the coil is wound around the tooth main-body portion.

Note that in the case in which a magnetic core including a tooth portion having an elliptical shape or a circular shape when viewed in the extending direction of the tooth portion is produced by press molding, a surface sharing a boundary with the first contact surface CS1 at the first protruding corner A1 and a surface sharing a boundary with the second contact surface CS2 at the second protruding corner A2 are formed. In the case in which the surface sharing a boundary with the first contact surface CS1 at the first protruding corner A1 and the surface sharing a boundary with the second contact surface CS2 at the second protruding corner A2 are the first non-contact surface NCS1 and the second non-contact surface NCS2, respectively, which the coil 13 does not come into contact with, it is possible to mitigate stress being concentrated at certain portions of the insulating film formed on the surface of the coil 13, reducing the damage of the insulating film.

The magnetic core 1 makes it easy to wind the coil 13 around the tooth main-body portion 31. More specifically, the coil 13 comes into contact with the first contact surface CS1 and the second contact surface CS2. Each of the first contact surface CS1 and the second contact surface CS2 has a semi-elliptical shape when viewed in the first direction DIR1. In the process of winding the coil 13, the coil 13 simply passes by the first protruding corner A1 and the second protruding corner A2. Hence, in the configuration of the magnetic core 1, it is easy to wind the coil 13 around the tooth main-body portion 31.

As for the magnetic core 1, in the case in which the magnetic core is produced by press molding, the tooth main-body portion can be produced by using an upper punch and a lower punch with end surfaces having the same shape. More specifically, the radius RCS2 of the second contact surface CS2 is equal to the radius RCS1 of the first contact surface CS1. Hence, the radius of the semi-elliptical portion of the end surface in the third direction DIR3 of the punch positioned in the second direction DIR2 relative to the tooth main-body portion 31 is equal to the radius of the semi-elliptical portion of the end surface in the second direction DIR2 of the punch positioned in the third direction DIR3 relative to the tooth main-body portion 31 Thus, in the configuration of the magnetic core 1, in the case in which the magnetic core is produced by press molding, the tooth main-body portion can be produced by using an upper punch and a lower punch with end surfaces having the same shape.

As for the magnetic core 1, in the case in which the magnetic core is produced by press molding, the tooth main-body portion can be produced by using an upper punch and a lower punch having the same shape. More specifically, the tooth main-body portion 31 has a point-symmetric shape when viewed in the first direction DIR1. Hence, the end surface in the third direction DIR3 of the punch positioned in the second direction DIR2 relative to the tooth main-body portion 31 and the end surface in the second direction DIR2 of the punch positioned in the third direction DIR3 relative to the tooth main-body portion 31 have a point-symmetric shape when viewed in the first direction DIR1. Thus, in the configuration of the magnetic core 1, in the case in which the magnetic core is produced by press molding, the tooth main-body portion can be produced by using an upper punch and a lower punch having the same shape.

### Second Embodiment

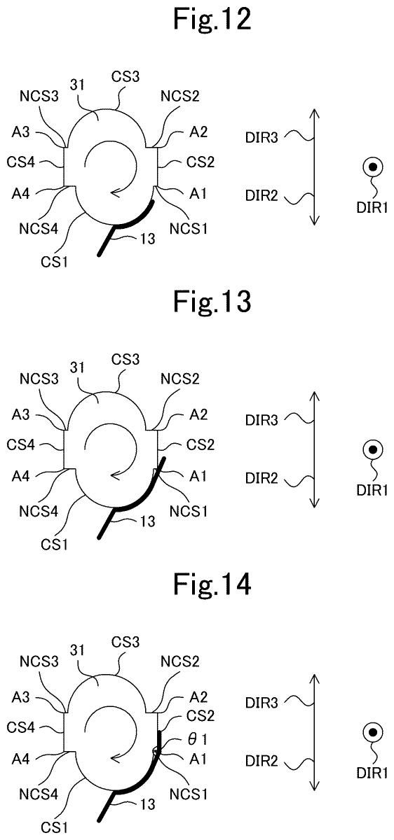

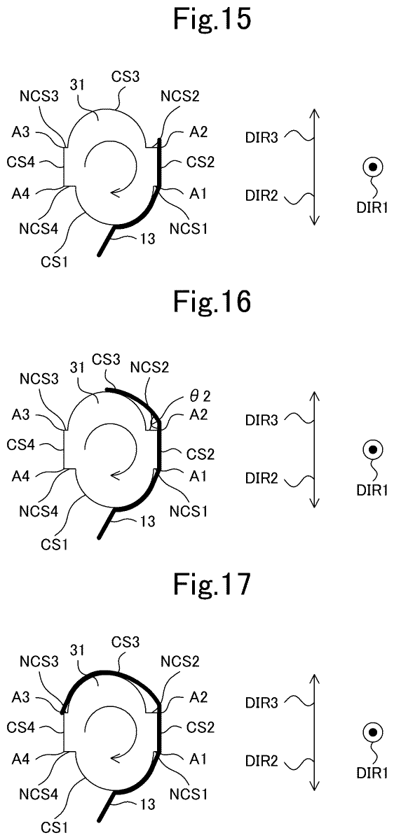

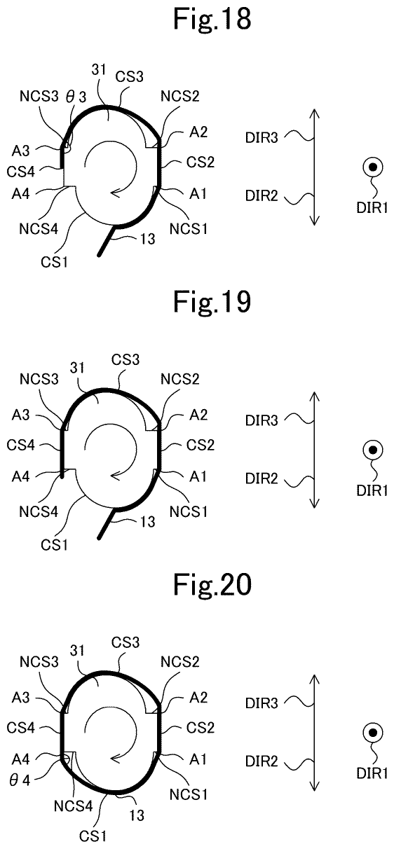

Hereinafter, a magnetic core 1a according to a second embodiment of the present disclosure will be described with reference to figures. FIG. 11 is a cross-sectional view of the magnetic core 1a viewed in the first direction DIR1. FIG. 12 is a cross-sectional view in the first direction DIR1, showing a process in which a coil 13 is wound around a tooth main-body portion 31 of the magnetic core 1a. FIG. 13 is a cross-sectional view in the first direction DIR1, showing the process in which the coil 13 is wound around the tooth main-body portion 31 of the magnetic core 1a. FIG. 14 is a cross-sectional view in the first direction DIR1, showing the process in which the coil 13 is wound around the tooth main-body portion 31 of the magnetic core 1a. FIG. 15 is a cross-sectional view in the first direction DIR1, showing the process in which the coil 13 is wound around the tooth main-body portion 31 of the magnetic core 1a. FIG. 16 is a cross-sectional view in the first direction DIR1, showing the process in which the coil 13 is wound around the tooth main-body portion 31 of the magnetic core 1a. FIG. 17 is a cross-sectional view in the first direction DIR1, showing the process in which the coil 13 is wound around the tooth main-body portion 31 of the magnetic core 1a. FIG. 18 is a cross-sectional view in the first direction DIR1, showing the process in which the coil 13 is wound around the tooth main-body portion 31 of the magnetic core 1a. FIG. 19 is a cross-sectional view in the first direction DIR1, showing the process in which the coil 13 is wound around the tooth main-body portion 31 of the magnetic core 1a. FIG. 20 is a cross-sectional view in the first direction DIR1, showing the process in which the coil 13 is wound around the tooth main-body portion 31 of the magnetic core 1a. As for the magnetic core 1a according to the second embodiment, only the portions different from those of the magnetic core 1 according to the first embodiment will be described, and description of the other portions will be omitted.

As illustrated in FIG. 11, the tooth main-body portion 31 includes a first contact surface CS1, a first non-contact surface NCS1, a first protruding corner A1, a second contact surface CS2, a second protruding corner A2, a second non-contact surface NCS2, a third contact surface CS3, a third non-contact surface NCS3, a third protruding corner A3, a fourth contact surface CS4, a fourth protruding corner A4, and a fourth non-contact surface NCS4.

As illustrated in FIG. 11, the first contact surface CS1 has a curved shape protruding in the second direction DIR2 when viewed in the first direction DIR1. More specifically, the first contact surface CS1 has a semi-elliptical shape when viewed in the first direction DIR1. Note that a semicircular shape is included in the category of semi-elliptical shapes. In the present embodiment, the first contact surface CS1 has a semicircular shape when viewed in the first direction DIR1. Specifically, the first contact surface CS1 is part of a circle centered on a center OCS1 and having a radius RCS1 when viewed in the first direction DIR1.

As illustrated in FIG. 11, the third contact surface CS3 is positioned in the third direction DIR3 relative to the first contact surface CS1. The third contact surface CS3 has a curved shape protruding in the third direction DIR3 when viewed in the first direction DIR1. More specifically, the third contact surface CS3 has a semi-elliptical shape when viewed in the first direction DIR1. Note that a semicircular shape is included in the category of semi-elliptical shapes. In the present embodiment, the third contact surface CS3 has a semicircular shape when viewed in the first direction DIR1. Specifically, the third contact surface CS3 is part of a circle centered on a center OCS3 and having a radius RCS3 when viewed in the first direction DIR1. The radius RCS3 of the third contact surface CS3 is equal to the radius RCS3 of the first contact surface CS1. The position of the center OCS3 in the fourth direction DIR4 differs from the position of the center OCS1 in the fourth direction DIR4.

As illustrated in FIG. 11, the second contact surface CS2 is located between the first contact surface CS1 and the third contact surface CS3. The second contact surface CS2 is a flat surface facing the opposite direction to the fourth direction DIR4. In other words, the normal line direction of the second contact surface CS2 is opposite to the fourth direction DIR4. In the present modification example, the second contact surface CS2 is positioned in the opposite direction to the fourth direction DIR4 relative to the first contact surface CS1, the third contact surface CS3, and the fourth contact surface CS4.

As illustrated in FIG. 11, the first non-contact surface NCS1 is located between the first contact surface CS1 and the second contact surface CS2. In the present modification example, the first non-contact surface NCS1 is a flat surface facing the second direction DIR2. In other words, the normal line direction of the first non-contact surface NCS1 corresponds to the second direction DIR2.

In the present embodiment, as illustrated in FIG. 11, the first protruding corner A1 is a corner formed by the first non-contact surface NCS1 and the second contact surface CS2 when viewed in the first direction DIR1. More specifically, the first protruding corner A1 protrudes in a radial direction centered on the center axis CA31 of the tooth main-body portion 31 when viewed in the first direction DIR1. Hence, the boundary between the first non-contact surface NCS1 and the second contact surface CS2 is the first protruding corner A1. In the present modification example, the angle of the first protruding corner A1 is 90 degrees.

As illustrated in FIG. 11, the second non-contact surface NCS2 is positioned in the third direction DIR3 relative to the first non-contact surface NCS1. The second non-contact surface NCS2 is a non-contact surface different from the first non-contact surface NCS1. More specifically, the second non-contact surface NCS2 is located between the second contact surface CS2 and the third contact surface CS3. The second non-contact surface NCS2 is a flat surface facing the third direction DIR3. In other words, the normal line direction of the second non-contact surface NCS2 corresponds to the third direction DIR3.

In the present embodiment, as illustrated in FIG. 11, the second protruding corner A2 is a protruding corner different from the first protruding corner A1. More specifically, the second protruding corner A2 is a corner formed by the second contact surface CS2 and the second non-contact surface NCS2 when viewed in the first direction DIR1. More specifically, the second protruding corner A2 protrudes in a radial direction centered on the center axis CA31 of the tooth main-body portion 31 when viewed in the first direction DIR1. Hence, the boundary between the second non-contact surface NCS2 and the second contact surface CS2 is the second protruding corner A2. In the present modification example, the angle of the second protruding corner A2 is 90 degrees.

As illustrated in FIG. 11, the fourth contact surface CS4 is located between the first contact surface CS1 and the third contact surface CS3. The fourth contact surface CS4 is a flat surface facing the fourth direction DIR4. In other words, the normal line direction of the fourth contact surface CS4 corresponds to the fourth direction DIR4. Hence, the fourth contact surface CS4 is parallel to the second contact surface CS2. The fourth contact surface CS4 is positioned in the fourth direction DIR4 relative to the first contact surface CS1, the second contact surface CS2, and the third contact surface CS3.

As illustrated in FIG. 11, the third non-contact surface NCS3 is located between the third contact surface CS3 and the fourth contact surface CS4. The third non-contact surface NCS3 is a flat surface facing the third direction DIR3. In other words, the normal line direction of the third non-contact surface NCS3 corresponds to the third direction DIR3. In the present modification example, the position of the third non-contact surface NCS3 in the second direction DIR2 is the same as the position of the second non-contact surface NCS2 in the second direction DIR2. The third non-contact surface NCS3 is positioned in the fourth direction DIR4 relative to the second non-contact surface NCS2.

In the present embodiment, as illustrated in FIG. 11, the third protruding corner A3 is a protruding corner different from the first protruding corner A1 and the second protruding corner A2. More specifically, the third protruding corner A3 is a corner formed by the third non-contact surface NCS3 and the fourth contact surface CS4 when viewed in the first direction DIR1. More specifically, the third protruding corner A3 protrudes in a radial direction centered on the center axis CA31 of the tooth main-body portion 31 when viewed in the first direction DIR1. Hence, the boundary between the third non-contact surface NCS3 and the fourth contact surface CS4 is the third protruding corner A3. In the present modification example, the angle of the third protruding corner A3 is 90 degrees.

As illustrated in FIG. 11, the fourth non-contact surface NCS4 is positioned in the second direction DIR2 relative to the third non-contact surface NCS3. The fourth non-contact surface NCS4 is a non-contact surface different from the third non-contact surface NCS3. More specifically, the fourth non-contact surface NCS4 is located between the fourth contact surface CS4 and the first contact surface CS1. The fourth non-contact surface NCS4 is a flat surface facing the second direction DIR2. In other words, the normal line direction of the fourth non-contact surface NCS4 corresponds to the second direction DIR2. In the present modification example, the position of the fourth non-contact surface NCS4 in the second direction DIR2 is the same as the position of the first non-contact surface NCS1 in the second direction DIR2. The fourth non-contact surface NCS4 is positioned in the fourth direction DIR4 relative to the first non-contact surface NCS1.

In the present embodiment, as illustrated in FIG. 11, the fourth protruding corner A4 is a protruding corner different from the first protruding corner A1, the second protruding corner A2, and the third protruding corner A3. More specifically, the fourth protruding corner A4 is a corner formed by the fourth contact surface CS4 and the fourth non-contact surface NCS4 when viewed in the first direction DIR1. More specifically, the fourth protruding corner A4 protrudes in a radial direction centered on the center axis CA31 of the tooth main-body portion 31 when viewed in the first direction DIR1. Hence, the boundary between the fourth non-contact surface NCS4 and the fourth contact surface CS4 is the fourth protruding corner A4. In the present modification example, the angle of the fourth protruding corner A4 is 90 degrees.

As illustrated in FIG. 11, the tooth main-body portion 31 has a point-symmetric shape when viewed in the first direction DIR1.

The process in which the coil 13 is wound around the tooth main-body portion 31 will be described below. As illustrated in FIG. 12, first, the coil 13 comes into contact with the first contact surface CS1. Specifically, the coil 13 comes into contact with the first contact surface CS1 before passing by the first protruding corner A1.

Next, as illustrated in FIG. 13, the coil 13 passes by the first protruding corner A1. In other words, the coil 13 comes into contact with the first protruding corner A1.

Next, as illustrated in FIG. 14, the coil 13 comes into contact with the second contact surface CS2.

Specifically, after the coil 13 passes by the first protruding corner A1, the coil 13 comes into contact with the second contact surface CS2. The coil 13 does not come into contact with the first non-contact surface NCS1. The bending angle θ1 of the coil 13 at the first protruding corner A1 is larger than 90 degrees.

Next, as illustrated in FIG. 15, the coil 13 passes by the second protruding corner A2. Specifically, after the coil 13 passes along the second contact surface CS2, the coil 13 passes by the second protruding corner A2. The coil 13 comes into contact with the second protruding corner A2.

Next, as illustrated in FIG. 16, the coil 13 comes into contact with the third contact surface CS3.

Specifically, after the coil 13 passes by the second protruding corner A2, the coil 13 comes into contact with the third contact surface CS3. The coil 13 does not come into contact with the second non-contact surface NCS2. The bending angle θ2 of the coil 13 between the second protruding corner A2 and the third contact surface CS3 is larger than 90 degrees. As illustrated in FIGS. 14 and 16, the bending angle θ2 of the coil 13 between the second protruding corner A2 and the third contact surface CS3 is smaller than the bending angle θ1 of the coil 13 at the first protruding corner A1.

Next, as illustrated in FIG. 17, the coil 13 passes by the third protruding corner A3. Specifically, after the coil 13 passes along the third contact surface CS3, the coil 13 passes by the third protruding corner A3. The coil 13 comes into contact with the third protruding corner A3.

Next, as illustrated in FIG. 18, the coil 13 comes into contact with the fourth contact surface CS4.

Specifically, after the coil 13 passes by the third protruding corner A3, the coil 13 comes into contact with the fourth contact surface CS4. The coil 13 does not come into contact with the third non-contact surface NCS3. The bending angle θ3 of the coil 13 at the third protruding corner A3 is larger than 90 degrees.

Next, as illustrated in FIG. 19, the coil 13 passes by the fourth protruding corner A4. Specifically, after the coil 13 passes along the fourth contact surface CS4, the coil 13 passes by the fourth protruding corner A4. The coil 13 comes into contact with the fourth protruding corner A4.

Next, as illustrated in FIG. 20, the coil 13 comes into contact with the first contact surface CS1.

Specifically, after the coil 13 passes by the fourth protruding corner A4, the coil 13 comes into contact with the first contact surface CS1 again. The coil 13 does not come into contact with the fourth non-contact surface NCS4. The bending angle θ4 of the coil 13 between the fourth protruding corner A4 and the first contact surface CS1 is larger than 90 degrees.

By repeating the process described above, the coil 13 is wound around the tooth main-body portion 31.

The magnetic core 1a reduces the degradation of the electrical insulation between the magnetic core and the coil due to the damage of the insulating film formed on the surface of the coil. More specifically, the magnetic core 1a includes the first contact surface CS1 having a curved shape protruding in the second direction DIR2 when viewed in the first direction DIR1 which is the extending direction of the tooth portion 3, the first protruding corner A1 which the coil 13 passes by, the second contact surface CS2 which the coil 13 passes along after passing by the first protruding corner A1, the first non-contact surface NCS1 sharing a boundary with the second contact surface CS2 at the first protruding corner A1, the second protruding corner A2 which the coil 13 passes by after passing along the second contact surface CS2, the third contact surface CS3 having a curved shape protruding in the third direction DIR3 different from the second direction DIR2 when viewed in the first direction DIR1 which is the extending direction of the tooth portion 3, and the second non-contact surface NCS2 sharing a boundary with the second contact surface CS2 at the second protruding corner A2. The first non-contact surface NCS1 is located between the first contact surface CS1 and the second contact surface CS2. The second non-contact surface NCS2 is located between the second contact surface CS2 and the third contact surface CS3. The coil 13 does not come into contact with the first non-contact surface NCS1 and the second non-contact surface NCS2. This configuration allows both of the bending angle θ1 of the coil 13 at the first protruding corner A1 and the bending angle θ2 of the coil 13 between the second protruding corner A2 and the third contact surface CS3 to be larger than 90 degrees. Hence, it is possible to mitigate stress being concentrated at certain portions of the insulating film formed on the surface of the coil 13, reducing the damage of the insulating film. Thus, the magnetic core 1a reduces the degradation of the electrical insulation between the magnetic core and the coil due to the damage of the insulating film formed on the surface of the coil.

Of the stress exerted on the insulating film formed on the surface of the coil 13, the stress exerted on the portion coming into contact with the protruding corner (the first protruding corner A1) that the coil 13 first passes by is large in the process in which the coil 13 is wound around the tooth main-body portion 31. However, since the bending angle θ1 of the coil 13 at the first protruding corner A1 is larger than the bending angle θ2 of the coil 13 between the second protruding corner A2 and the third contact surface CS3, this configuration further mitigates stress concentration, reducing the damage of the insulating film.

The magnetic core 1a further reduces the degradation of the electrical insulation between the magnetic core and the coil due to the damage of the insulating film formed on the surface of the coil. More specifically, the magnetic core 1a further includes the third protruding corner A3 which the coil 13 passes by after passing along the third contact surface CS3, the fourth contact surface CS4 which the coil 13 passes along after passing by the third protruding corner A3, the third non-contact surface NCS3 sharing a boundary with the fourth contact surface CS4 at the third protruding corner A3, the fourth protruding corner A4 which the coil 13 passes by after passing along the fourth contact surface CS4, and the fourth non-contact surface NCS4 sharing a boundary with the fourth contact surface CS4 at the fourth protruding corner A4. The coil 13 does not come into contact with the third non-contact surface NCS3 and the fourth non-contact surface NCS4. This configuration allows both of the bending angle θ3 of the coil 13 at the third protruding corner A3 and the bending angle θ4 of the coil 13 between the fourth protruding corner A4 and the first contact surface CS1 to be larger than 90 degrees. Hence, it is possible to mitigate stress being concentrated at certain portions of the insulating film formed on the surface of the coil 13, reducing the damage of the insulating film. Thus, the magnetic core 1a reduces the degradation of the electrical insulation between the magnetic core and the coil due to the damage of the insulating film formed on the surface of the coil.

The magnetic core 1a makes it easy to wind the coil 13 around the tooth main-body portion 31. More specifically, the coil 13 comes into contact with the first contact surface CS1 and the third contact surface CS3. Each of the first contact surface CS1 and the third contact surface CS3 has a semi-elliptical shape when viewed in the first direction DIR1. In the process of winding the coil 13, the coil 13 simply passes by the first protruding corner A1, the second protruding corner A2, the third protruding corner A3, and the fourth protruding corner A4. Thus, in the configuration of the magnetic core 1a, it is easy to wind the coil 13 around the tooth main-body portion 31.

As for the magnetic core 1a, in the case in which the magnetic core is produced by press molding, the tooth main-body portion can be produced by using an upper punch and a lower punch with end surfaces having the same shape. More specifically, the radius RCS3 of the third contact surface CS3 is equal to the radius RCS1 of the first contact surface CS1. Hence, the radius of the semi-elliptical portion of the end surface in the third direction DIR3 of the punch positioned in the second direction DIR2 relative to the tooth main-body portion 31 is equal to the radius of the semi-elliptical portion of the end surface in the second direction DIR2 of the punch positioned in the third direction DIR3 relative to the tooth main-body portion 31. Thus, in the configuration of the magnetic core 1a, in the case in which the magnetic core is produced by press molding, the tooth main-body portion can be produced by using an upper punch and a lower punch with end surfaces having the same shape.

As for the magnetic core 1a, in the case in which the magnetic core is produced by press molding, the tooth main-body portion can be produced by using an upper punch and a lower punch having the same shape. More specifically, the tooth main-body portion 31 has a point-symmetric shape when viewed in the first direction DIR1. Hence, the end surface in the third direction DIR3 of the punch positioned in the second direction DIR2 relative to the tooth main-body portion 31 and the end surface in the second direction DIR2 of the punch positioned in the third direction DIR3 relative to the tooth main-body portion 31 have a point-symmetric shape when viewed in the first direction DIR1. Thus, in the configuration of the magnetic core 1a, in the case in which the magnetic core is produced by press molding, the tooth main-body portion can be produced by using an upper punch and a lower punch having the same shape.

### First Modification Example

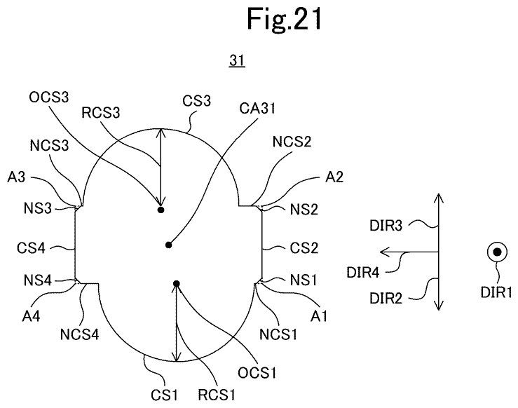

Hereinafter, a magnetic core 1b according to a first modification example of the present disclosure will be described with reference to figures. FIG. 21 is a cross-sectional view of the magnetic core 1b viewed in the first direction DIR1. As for the magnetic core 1b according to the first modification example, only the portions different from those of the magnetic core 1a according to the second embodiment will be described, and the description of the other portions will be omitted.

As illustrated in FIG. 21, the magnetic core 1b differs from the magnetic core 1a in that the second contact surface CS2 is connected to each of the first non-contact surface NCS1 and the second non-contact surface NCS2 with a chamfered surface interposed therebetween and in that the fourth contact surface CS4 is connected to each of the third non-contact surface NCS3 and the fourth non-contact surface NCS4 with a chamfered surface interposed therebetween.

More specifically, as illustrated in FIG. 21, the tooth main-body portion 31 further includes a first chamfered surface NS1, a second chamfered surface NS2, a third chamfered surface NS3, and a fourth chamfered surface NS4.

Specifically, the first chamfered surface NS1, the second chamfered surface NS2, the third chamfered surface NS3, and the fourth chamfered surface NS4 have shapes formed by chamfering the first protruding corner A1, the second protruding corner A2, the third protruding corner A3, and the fourth protruding corner A4, respectively. In the present modification example, each of the first chamfered surface NS1, the second chamfered surface NS2, the third chamfered surface NS3, and the fourth chamfered surface NS4 is a flat surface. Hence, the first non-contact surface NCS1 is connected to the second contact surface CS2 with the first chamfered surface NS1 interposed therebetween. The second non-contact surface NCS2 is connected to the second contact surface CS2 with the second chamfered surface NS2 interposed therebetween. The third non-contact surface NCS3 is connected to the fourth contact surface CS4 with the third chamfered surface NS3 interposed therebetween. The fourth non-contact surface NCS4 is connected to the fourth contact surface CS4 with the fourth chamfered surface NS4 interposed therebetween.

The magnetic core 1b further reduces the degradation of the electrical insulation between the magnetic core and the coil due to the damage of the insulating film formed on the surface of the coil. More specifically, the second contact surface CS2 is connected to each of the first non-contact surface NCS1 and the second non-contact surface NCS2 with a chamfered surface interposed therebetween. This configuration increases the bending angle θ1 of the coil 13 at the first protruding corner A1 and the bending angle θ2 of the coil 13 between the second protruding corner A2 and the third contact surface CS3. Accordingly, this configuration mitigates stress being concentrated at the portion at the first protruding corner A1 in the insulating film formed on the surface of the coil 13 and the portion between the second protruding corner A2 and the third contact surface CS3 in the insulating film formed on the surface of the coil 13, reducing the damage of the insulating film formed on the surface of the coil. Thus, the magnetic core 1b reduces the degradation of the electrical insulation between the magnetic core and the coil due to the damage of the insulating film formed on the surface of the coil.

The magnetic core 1b further reduces the degradation of the electrical insulation between the magnetic core and the coil due to the damage of the insulating film formed on the surface of the coil. More specifically, the fourth contact surface CS4 is connected to each of the third non-contact surface NCS3 and the fourth non-contact surface NCS4 with a chamfered surface interposed therebetween. This configuration increases the bending angle θ3 of the coil 13 at the third protruding corner A3 and the bending angle θ4 of the coil 13 between the fourth protruding corner A4 and the first contact surface CS1. Accordingly, this configuration mitigates stress being concentrated at the portion at the third protruding corner A3 in the insulating film formed on the surface of the coil 13 and the portion between the fourth protruding corner A4 and the first contact surface CS1 in the insulating film formed on the surface of the coil 13, reducing the damage of the insulating film formed on the surface of the coil. Thus, the magnetic core 1b reduces the degradation of the electrical insulation between the magnetic core and the coil due to the damage of the insulating film formed on the surface of the coil.

### OTHER EMBODIMENTS

The magnetic core according to the present disclosure is not limited to the magnetic cores 1, 1a, and 1b and may be changed within the scope of the spirit thereof. The structures of the magnetic cores 1, 1a, and 1b may be combined as appropriate.

Note that the rotating electrical machine needs only to include a structure in which electricity rotates the rotor or a structure in which the rotation of the rotor generates electricity. In this case, the rotating electrical machine needs only to include at least one of the magnetic cores 1, 1a, and 1b and may also include brushes.

Note that each of the first main surface S1 and the second main surface S2 of the core back portion 2 is not limited to one having a rectangular shape when viewed in the first direction DIR1.

Note that the tooth main-body portion 31 of the magnetic core 1 does not necessarily need to include the second protruding corner A2 and the second non-contact surface NCS2.

Note that in the magnetic core 1, the first contact surface CS1 and the second contact surface CS2 are not limited to ones having a semi-elliptical shape when viewed in the first direction DIR1.

Note that the second direction DIR2 does not necessarily need to be orthogonal to the first direction DIR1. The second direction DIR2 does not necessarily need to be a direction parallel to the rotation axis of the brushless motor 100 in the state in which the magnetic core 1 is assembled in the brushless motor 100.

Note that in the magnetic core 1, the first non-contact surface NCS1 is not limited to a flat surface facing the third direction DIR3. Hence, the first non-contact surface NCS1 may be a flat surface facing a direction different from the third direction DIR3 or may be a curved surface.

Note that the third direction DIR3 does not necessarily need to be the opposite direction to the second direction DIR2.

Note that in the magnetic core 1, the first protruding corner A1 is not limited to a corner formed by the first contact surface CS1 and the tangent line of the first non-contact surface NCS1 at the first protruding corner A1 when viewed in the first direction DIR1.

Note that each of the first protruding corner A1, the second protruding corner A2, the third protruding corner A3, and the fourth protruding corner A4 does not necessarily need to be 90 degrees.

Note that in the magnetic core 1, the radius RCS2 of the second contact surface CS2 may differ from the radius RCS1 of the first contact surface CS1.

Note that in the magnetic core 1, the second non-contact surface NCS2 is not limited to a flat surface facing the second direction DIR2. The second non-contact surface NCS2 may be a flat surface facing a direction different from the second direction DIR2 or may be a curved surface.

Note that in the magnetic core 1, the second protruding corner A2 is not limited to a corner formed by the second contact surface CS2 and the tangent line of the second non-contact surface NCS2 at the second protruding corner A2 when viewed in the first direction DIR1.

Note that the tooth main-body portion 31 is not limited to one having a point-symmetric shape when viewed in the first direction DIR1.

Note that each of the third main surface S3 and the fourth main surface S4 of the tooth distal-end portion 32 is not limited to one having a rectangular shape when viewed in the first direction DIR1.

Note that the outer edge O2 of the core back portion 2 viewed in the first direction DIR1 is not limited to one surrounding the outer edge O31 of the tooth main-body portion 31 viewed in the first direction DIR1. The outer edge O32 of the tooth distal-end portion 32 viewed in the first direction DIR1 is not limited to one surrounding the outer edge O31 of the tooth main-body portion 31 viewed in the first direction DIR1.

Note that the brushless motor 100 may be an outer rotor motor.

Note that the brushless motor 100 is not limited to a single-shaft motor. The brushless motor 100 may be, for example, a double-shaft motor.

Note that the first bearing 11a and the second bearing 11b is not limited to ball bearings.

Note that the material of the first housing 12a and the second housing 12b needs only to have high stiffness.

Note that the number of coil-equipped magnetic cores 14 is not limited to nine.

Note that in the magnetic core 1a, the tooth main-body portion 31 is not limited to one including the third protruding corner A3, the fourth protruding corner A4, the fourth contact surface CS4, the third non-contact surface NCS3, and the fourth non-contact surface NCS4.

Note that in the magnetic core 1a, the first contact surface CS1 and the third contact surface CS3 are not limited to ones having a semi-elliptical shape when viewed in the first direction DIR1.

Note that in the magnetic core 1a, the radius RCS3 of the third contact surface CS3 may differ from the radius RCS1 of the first contact surface CS1.

Note that in the magnetic core 1a, the second contact surface CS2 is not limited to a flat surface facing the opposite direction to the fourth direction DIR4. The second contact surface CS2 may be a flat surface facing a direction different from the opposite direction to the fourth direction DIR4 or may be a curved surface.

Note that in the magnetic core 1a, the first non-contact surface NCS1 is not limited to a flat surface facing the second direction DIR2. The first non-contact surface NCS1 may be a flat surface facing a direction different from the second direction DIR2 or may be a curved surface.

Note that in the magnetic core 1a, the first protruding corner A1 is not limited to a corner formed by the first non-contact surface NCS1 and the second contact surface CS2 when viewed in the first direction DIR1.

Note that in the magnetic core 1a, the second non-contact surface NCS2 is not limited to a flat surface facing the third direction DIR3. The second non-contact surface NCS2 may be a flat surface facing a direction different from the third direction DIR3 or may be a curved surface.

Note that in the magnetic core 1a, the second protruding corner A2 is not limited to a corner formed by the second contact surface CS2 and the second non-contact surface NCS2 when viewed in the first direction DIR1.

Note that in the magnetic core 1a, the fourth contact surface CS4 is not limited to a flat surface facing the fourth direction DIR4. The fourth contact surface CS4 may be a flat surface facing a direction different from the fourth direction DIR4 or may be a curved surface.

Note that in the magnetic core 1a, the third non-contact surface NCS3 is not limited to a flat surface facing the third direction DIR3. The third non-contact surface NCS3 may be a flat surface facing a direction different from the third direction DIR3 or may be a curved surface.

Note that in the magnetic core 1a, the position of the third non-contact surface NCS3 in the second direction DIR2 may differ from the position of the second non-contact surface NCS2 in the second direction DIR2.

Note that in the magnetic core 1a, the third protruding corner A3 is not limited to a corner formed by the third non-contact surface NCS3 and the fourth contact surface CS4 when viewed in the first direction DIR1.

Note that in the magnetic core 1a, the fourth non-contact surface NCS4 is not limited to a flat surface facing the second direction DIR2. The fourth non-contact surface NCS4 may be a flat surface facing a direction different from the second direction DIR2 or may be a curved surface.

Note that in the magnetic core 1a, the position of the fourth non-contact surface NCS4 in the second direction DIR2 may differ from the position of the first non-contact surface NCS1 in the second direction DIR2.

Note that in the magnetic core 1a, the fourth protruding corner A4 is not limited to a corner formed by the fourth contact surface CS4 and the fourth non-contact surface NCS4 when viewed in the first direction DIR1.

Note that in the magnetic core 1a, the bending angle θ2 of the coil 13 between the second protruding corner A2 and the third contact surface CS3 does not necessarily need to be smaller than the bending angle θ1 of the coil 13 at the first protruding corner A1.

Note that in the magnetic core 1b, the first protruding corner A1, the second protruding corner A2, the third protruding corner A3, and the fourth protruding corner A4 may be rounded. Specifically, the first chamfered surface NS1, the second chamfered surface NS2, the third chamfered surface NS3, and the fourth chamfered surface NS4 may be curved surfaces.

Note that in the magnetic core 1b, the tooth main-body portion 31 does not necessarily need to include the third chamfered surface NS3 and the fourth chamfered surface NS4. Specifically, the fourth contact surface CS4 is not limited to one connected to the third non-contact surface NCS3 and the fourth non-contact surface NCS4 with a chamfered surface interposed therebetween.

The present disclosure includes the following configurations.

(1) A magnetic core for a rotating electrical machine, the magnetic core including: a tooth portion having a shape extending in a first direction, wherein the tooth portion includes a winding portion around which a coil is to be wound, and the winding portion includes: a first protruding corner constructed such that the coil passes thereby when the coil is wound on the winding portion, a first contact surface constructed such that the coil comes into contact therewith before passing by the first protruding corner when the coil is wound on the winding portion, and that has a first curved shape protruding in a second direction when viewed in the first direction, a first non-contact surface constructed such that the coil does not come into contact therewith when the coil is wound on the winding portion, and that shares a boundary with the first contact surface at the first protruding corner, and a second contact surface constructed such that the coil comes into contact therewith after passing by the first protruding corner when the coil is wound on the winding portion, and that has a second curved shape protruding in a third direction different from the second direction when viewed in the first direction.

(2) The magnetic core according to (1), in which the winding portion further includes: a second protruding corner constructed such that the coil passes thereby after passing along the second contact surface when the coil is wound on the winding portion, and a second non-contact surface constructed such that the coil does not come into contact therewith when the coil is wound on the winding portion, and that shares a boundary with the second contact surface at the second protruding corner, and the first contact surface is constructed such that the coil comes into contact with the first contact surface after the coil passes by the second protruding corner when the coil is wound on the winding portion.

(3) The magnetic core according to (1) or (2), in which each of the first contact surface and the second contact surface has a semi-elliptical shape when viewed in the first direction.

(4) The magnetic core according to (3), in which the radius of the first contact surface is equal to the radius of the second contact surface.

(5) The magnetic core according to any one of (1) to (4), in which the winding portion has a point-symmetric shape when viewed in the first direction.

(6) A magnetic core for a rotating electrical machine, the magnetic core including: a tooth portion having a shape extending in a first direction, wherein the tooth portion includes a winding portion around which a coil is to be wound, and the winding portion includes: a first protruding corner constructed such that the coil passes thereby when the coil is wound on the winding portion, a first contact surface constructed such that the coil comes into contact therewith before passing by the first protruding corner when the coil is wound on the winding portion, and that has a first curved shape protruding in a second direction when viewed in the first direction, a second contact surface constructed such that the coil comes into contact therewith after passing by the first protruding corner when the coil is wound on the winding portion, a first non-contact surface between the first contact surface and the second contact surface, constructed such that the coil does not come into contact therewith when the coil is wound on the winding portion, and that shares a boundary with the second contact surface at the first protruding corner, a second protruding corner constructed such that the coil passes thereby after passing along the second contact surface when the coil is wound on the winding portion, a third contact surface constructed such that the coil comes into contact therewith after passing by the second protruding corner when the coil is wound on the winding portion, and that has a third curved shape protruding in a third direction different from the second direction when viewed in the first direction, and a second non-contact surface between the second contact surface and the third contact surface, constructed such that the coil does not come into contact therewith when the coil is wound on the winding portion, and that shares a boundary with the second contact surface at the second protruding corner.

(7) The magnetic core according to (6), in which the winding portion further includes: a third protruding corner constructed such that the coil passes thereby after passing along the third contact surface when the coil is wound on the winding portion, a fourth contact surface constructed such that the coil comes into contact therewith after passing by the third protruding corner when the coil is wound on the winding portion, a third non-contact surface between the third contact surface and the fourth contact surface, constructed such that the coil does not come into contact therewith when the coil is wound on the winding portion, and that shares a boundary with the fourth contact surface at the third protruding corner, a fourth protruding corner constructed such that the coil passes thereby after passing along the fourth contact surface when the coil is wound on the winding portion, and a fourth non-contact surface between the fourth contact surface and the first contact surface, constructed such that the coil does not come into contact therewith when the coil is wound on the winding portion, and that shares a boundary with the fourth contact surface at the fourth protruding corner, and the first contact surface is constructed such that the coil comes into contact with the first contact surface after the coil passes by the fourth protruding corner when the coil is wound on the winding portion.

(8) The magnetic core according to (6) or (7), in which each of the first contact surface and the third contact surface has a semi-elliptical shape when viewed in the first direction.

(9) The magnetic core according to (8), in which a radius of the first contact surface is equal to a radius of the third contact surface.

(10) The magnetic core according to any one of (6) to (9), in which the winding portion has a point-symmetric shape when viewed in the first direction.

(11) The magnetic core according to any one of (6) to (10), in which the second contact surface is connected to each of the first non-contact surface and the second non-contact surface with a chamfered or rounded surface interposed therebetween.

(12) The magnetic core according to (7), in which the fourth contact surface is connected to each of the third non-contact surface and the fourth non-contact surface with a chamfered or rounded surface interposed therebetween.

(13) The magnetic core according to any one of (1) to (12), in which the tooth portion is a molded body comprising soft magnetic powder.

(14) A coil-equipped magnetic core including: the magnetic core according to any one of (1) to (13); and the coil.

(15) A rotating electrical machine including the magnetic core according to any one of (1) to (13).

(16) A brushless motor including the magnetic core according to any one of (1) to (13).

### REFERENCE SIGNS LIST

1, 1a, 1b MAGNETIC CORE
2 CORE BACK PORTION
3 TOOTH PORTION
10 STATOR ASSEMBLY
11 BEARING
11a FIRST BEARING
11b SECOND BEARING
12 HOUSING
12a FIRST HOUSING
12b SECOND HOUSING
13 COIL
14 COIL-EQUIPPED MAGNETIC CORE
20 ROTOR
21 SHAFT
22 ROTOR MEMBER
23 SOFT MAGNETIC MATERIAL
24 HARD MAGNETIC MATERIAL
31 TOOTH MAIN-BODY PORTION
32 TOOTH DISTAL-END PORTION
100 BRUSHLESS MOTOR
A1 FIRST PROTRUDING CORNER
A2 SECOND PROTRUDING CORNER
A3 THIRD PROTRUDING CORNER
A4 FOURTH PROTRUDING CORNER
CA31 CENTER AXIS
CS1 FIRST CONTACT SURFACE
CS2 SECOND CONTACT SURFACE
CS3 THIRD CONTACT SURFACE
CS4 FOURTH CONTACT SURFACE
DIR1 FIRST DIRECTION
DIR2 SECOND DIRECTION
DIR3 THIRD DIRECTION
DIR4 FOURTH DIRECTION
NCS1 FIRST NON-CONTACT SURFACE
NCS2 SECOND NON-CONTACT SURFACE
NCS3 THIRD NON-CONTACT SURFACE
NCS4 FOURTH NON-CONTACT SURFACE
NS1 FIRST CHAMFERED SURFACE
NS2 SECOND CHAMFERED SURFACE
NS3 THIRD CHAMFERED SURFACE
NS4 FOURTH CHAMFERED SURFACE
O2, O31, O32 OUTER EDGE
OCS1, OCS2, OCS3 CENTER
OP OPENING
RCS1, RCS2, RCS3 RADIUS
S1 FIRST MAIN SURFACE
S2 SECOND MAIN SURFACE
S3 THIRD MAIN SURFACE
S4 FOURTH MAIN SURFACE
θ1, θ2, θ3, θ4 BENDING ANGLE

1. A magnetic core for a rotating electrical machine, the magnetic core comprising:
a tooth portion having a shape extending in a first direction, wherein the tooth portion includes a winding portion around which a coil is to be wound, and the winding portion includes:
a first protruding corner constructed such that the coil passes thereby when the coil is wound on the winding portion,
a first contact surface constructed such that the coil comes into contact therewith before passing by the first protruding corner when the coil is wound on the winding portion, and that has a first curved shape protruding in a second direction when viewed in the first direction,
a first non-contact surface constructed such that the coil does not come into contact therewith when the coil is wound on the winding portion, and that shares a boundary with the first contact surface at the first protruding corner, and
a second contact surface constructed such that the coil comes into contact therewith after passing by the first protruding corner when the coil is wound on the winding portion, and that has a second curved shape protruding in a third direction different from the second direction when viewed in the first direction.

2. The magnetic core according to claim 1, wherein the winding portion further includes:
a second protruding corner constructed such that the coil passes thereby after passing along the second contact surface when the coil is wound on the winding portion, and
a second non-contact surface constructed such that the coil does not come into contact therewith when the coil is wound on the winding portion, and that shares a boundary with the second contact surface at the second protruding corner, and
the first contact surface is constructed such that the coil comes into contact with the first contact surface after the coil passes by the second protruding corner when the coil is wound on the winding portion.

3. The magnetic core according to claim 1, wherein each of the first contact surface and the second contact surface has a semi-elliptical shape when viewed in the first direction.

4. The magnetic core according to claim 3, wherein a radius of the first contact surface is equal to a radius of the second contact surface.

5. The magnetic core according to claim 1, wherein the winding portion has a point-symmetric shape when viewed in the first direction.

6. The magnetic core according to claim 1, wherein the tooth portion is a molded body comprising soft magnetic powder.

7. A coil-equipped magnetic core comprising: the magnetic core according to claim 1; and the coil.

8. A rotating electrical machine comprising the magnetic core according to claim 1.

9. A magnetic core for a rotating electrical machine, the magnetic core comprising:
a tooth portion having a shape extending in a first direction, wherein the tooth portion includes a winding portion around which a coil is to be wound, and the winding portion includes:
a first protruding corner constructed such that the coil passes thereby when the coil is wound on the winding portion,
a first contact surface constructed such that the coil comes into contact therewith before passing by the first protruding corner when the coil is wound on the winding portion, and that has a first curved shape protruding in a second direction when viewed in the first direction,
a second contact surface constructed such that the coil comes into contact therewith after passing by the first protruding corner when the coil is wound on the winding portion,
a first non-contact surface between the first contact surface and the second contact surface, constructed such that the coil does not come into contact therewith when the coil is wound on the winding portion, and that shares a boundary with the second contact surface at the first protruding corner,
a second protruding corner constructed such that the coil passes thereby after passing along the second contact surface when the coil is wound on the winding portion,
a third contact surface constructed such that the coil comes into contact therewith after passing by the second protruding corner when the coil is wound on the winding portion, and that has a third curved shape protruding in a third direction different from the second direction when viewed in the first direction, and
a second non-contact surface between the second contact surface and the third contact surface, constructed such that the coil does not come into contact therewith when the coil is wound on the winding portion, and that shares a boundary with the second contact surface at the second protruding corner.

10. The magnetic core according to claim 9, wherein a position of a portion of the first contact surface protruding most in the second direction differs from a position of a portion of the third contact surface protruding most in the third direction in a fourth direction orthogonal to the first direction and the second direction.

11. The magnetic core according to claim 9, wherein the winding portion further includes:
a third protruding corner constructed such that the coil passes thereby after passing along the third contact surface when the coil is wound on the winding portion,
a fourth contact surface constructed such that the coil comes into contact therewith after passing by the third protruding corner when the coil is wound on the winding portion,
a third non-contact surface between the third contact surface and the fourth contact surface, constructed such that the coil does not come into contact therewith when the coil is wound on the winding portion, and that shares a boundary with the fourth contact surface at the third protruding corner,
a fourth protruding corner constructed such that the coil passes thereby after passing along the fourth contact surface when the coil is wound on the winding portion, and
a fourth non-contact surface between the fourth contact surface and the first contact surface, constructed such that the coil does not come into contact therewith when the coil is wound on the winding portion, and that shares a boundary with the fourth contact surface at the fourth protruding corner, and
the first contact surface is constructed such that the coil comes into contact with the first contact surface after the coil passes by the fourth protruding corner when the coil is wound on the winding portion.

12. The magnetic core according to claim 9, wherein each of the first contact surface and the third contact surface has a semi-elliptical shape when viewed in the first direction.

13. The magnetic core according to claim 12, wherein a radius of the first contact surface is equal to a radius of the third contact surface.

14. The magnetic core according to claim 9, wherein the winding portion has a point-symmetric shape when viewed in the first direction.

15. The magnetic core according to claim 9, wherein the second contact surface is connected to each of the first non-contact surface and the second non-contact surface with a chamfered or rounded surface interposed therebetween.

16. The magnetic core according to claim 11, wherein the fourth contact surface is connected to each of the third non-contact surface and the fourth non-contact surface with a chamfered or rounded surface interposed therebetween.

17. The magnetic core according to claim 9, wherein the tooth portion is a molded body comprising soft magnetic powder.

18. A coil-equipped magnetic core comprising: the magnetic core according to claim 9; and the coil.

19. A rotating electrical machine comprising the magnetic core according to claim 9.

20. A brushless motor comprising the magnetic core according to claim 9.
